(19) United States
(12) Patent Application Publication
(10) Pub. No.: US 2023/0419245 A1
(43) Pub. Date: Dec. 28, 2023

(54) Transport Dispatch System for Route Selection

(71) Applicant: SAP SE, Walldorf (DE)

(72) Inventors: Jie He, Shanghai (CN); Dongliang Zhang, Chengdu (CN); Zhao Zhang, Chengdu (CN); Qian Yang, Beijing (CN); Xuemin Wang, Shanghai (CN)

(21) Appl. No.: 17/846,103

(22) Filed: Jun. 22, 2022

(51) Int. Cl. G06Q 10/08

(52) U.S. Cl. CPC G06Q 10/08355; G06Q 10/087; G06Q 10/0833

(57) ABSTRACT

Various embodiments for a transport dispatch system for route selection are described herein. An embodiment operates by determining the total quantity of goods to be shipped to the plurality of railway stations. A plurality of variations of the shipping route are identified. A user-provided metric is computing for each of the plurality of variations of the shipping route. A first variation is identified from the plurality of variations of the shipping route for which the computed user-provided metric is lower than a remainder of the plurality of variations of the shipping route, The first variation of the shipping route is provided indicating an order in which each of the plurality of stations receives its portion of the total quantity of goods based on its request.

### CROSS-REFERENCE TO RELATED APPLICATIONS

This application is related to U.S. patent application Ser. No. ______ titled “Transport Dispatch System for Trailer Assignment”, to He et al., filed herewith, which is herein incorporated by reference in its entirety.

### BACKGROUND

When it comes to the transportation of goods, dispatchers have the difficult task of trying to figure out the best way to transport the goods to different locations in the most time and cost efficient way possible. The route a dispatcher chooses to transport the goods can impact profitability and productivity of organizations, because longer or less efficient routes consume more fuel, waste manpower, and take more time than using other more efficient routes. However, trying to calculate the best or most efficient route is both difficult, and extraordinarily time consuming because of the number of factors and variables that must be considered.

### BRIEF DESCRIPTION OF THE FIGURES

The accompanying drawings are incorporated herein and form a part of the specification.

FIG. 1 illustrates a block diagram illustrating a transport dispatch system (TDS) 102, according to some example embodiments.

FIG. 2 is an example user interface of TDS, according to some example embodiments.

FIG. 3 is a flowchart illustrating a process for identifying a shipping route as performed by a transport dispatch system (TDS), according to some embodiments.

FIG. 4 illustrates several example types of cars that may be used in transporting goods, according to some embodiments.

FIG. 5 illustrates an example user interface that illustrates an example open request to be fulfilled, according to some embodiments.

FIG. 6 is an example user interface that illustrates the availability and uses of different types of supply cars that may be used to transport various materials, according to some embodiments.

FIG. 7 is an example user interface that illustrates a trailer assignment display, according to some embodiments.

FIG. 8 is a flowchart illustrating a process for generating a trailer assignment as performed by a transport dispatch system (TDS), according to some embodiments.

FIG. 9 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

When it comes to the transportation of goods, dispatchers have the difficult task of trying to figure out the best way to transport the goods to different locations in the most time and cost efficient way possible. The route a dispatcher chooses to transport the goods can impact profitability and productivity of organizations, because longer or less efficient routes consume more fuel, waste manpower, and take more time than using other more efficient routes. However, trying to calculate the best or most efficient route is both difficult, and extraordinarily time consuming because of the number of factors and variables that must be considered.

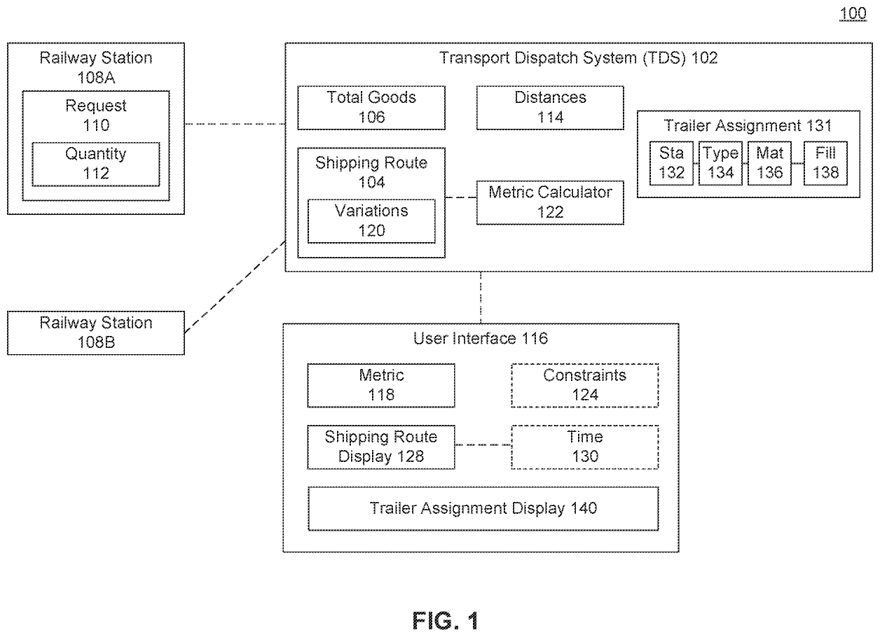

FIG. 1 illustrates a block diagram 100 illustrating a transport dispatch system (TDS) 102, according to some example embodiments. In some embodiments, TDS 102 may generate an optimal or most efficient shipping route 104 to ship total goods 106 to a group of railway stations 108A, 108B (herein referred to collectively, or individually, as station 108).

Station 108 may include any type of transportation station or hub, including but not limited to railway stations. In some embodiments, station 108 may include a shipping port, an airport, train station (above ground or underground), bus or truck terminal, or any other transportation hub through which materials or goods may be received (and distributed or used). Stations 108 may include any ports or locations that receive a quantity of goods from a single vehicle (or group of vehicles traveling together). For the sake of simplicity, the primary example described herein will be that of a train engine delivering the total goods 106 to the railway stations 108.

Total goods 106 may include an indication of a quantity of goods that are to be shipped to the various railway stations 108A, 108B based on a request 110 received from each station 108. Total goods 106 may include any combinations of materials, supplies, equipment, people/workers, packages, vehicles, etc., all of which are referred to herein generally as “goods”. The total goods 106 may represent the aggregation or sum of all the goods to be shipped, as one shipment or using a single transportation vehicle/train engine, to the various railway stations 108A, 108B from which requests 110 were received.

For example, if railway station 108A requests 10 tons of salt, and 2 tons of water, and railway station 108B requests 4 tons of gravel, and 2 tons of salt, the total goods 106 may be 18 tons of goods (12 tons to station 108A, and 6 tons to station 108B), or may further be broken down to specify 12 tons of salt, 2 tons of water, and 4 tons of gravel. As just indicated, in some embodiments, the total goods 106 may simply be the accumulated quantity of goods to be shipped. In some other embodiments, the total goods 106 may be the total number of packages, or people being transported to the railway stations 108A, 108B.

In some embodiments, TDS 102 may receive a request 110 from each (or a subset) of the various railway stations 108A, 108B. For the sake of simplicity, only a single request 110 is illustrated for railway station 108A, however it is understood each railway station 108 may include or provide its own request 110. These various requests 110 may then be combined (in whole or in part) into a master request 110 for the total goods 106.

Request 110 may include an order for goods, which may be a one-time order or a regularly scheduled order. Request 110 may include a variety of different goods and may indicate the quantity 112 of the various goods, and specify a date/time by which the goods may be required. In the example above, request 110 from railway station 108A may include a quantity 112 for 12 tons of goods, or a first quantity 112 for 10 tons of salt, and a second quantity 112 for 2 tons of water. Quantity 112 may indicate how much of each good or material is being requested as part of request 110.

In some embodiments, TDS 102 may group requests 110 from different railway stations 108A, 108B into a single order or request to be delivered by a single vehicle, truck, ship, train, etc. In some embodiments, a single request 110 from a particular station 108 may be separated into two or more shipments. TDS 102 may aggregate all the quantities 112 from the various combined requests 110 to be shipped together to calculate total goods 106. TDS 102 may then identify what would be the best, optimized, or most efficient shipping route 104 to ship the total goods 106 to the various railway stations 108A, 108B (using the least amount of cars, fuel, time, etc.).

In some embodiments, TDS 102 may generate a route for independent delivery tasks rather than composite delivery tasks. Independent delivery tasks may include a situation in which a locomotive or other delivery vehicle separately transports the cargo to stations one by one. For example, materials or goods for different stations would not share the same trailer. Also, the locomotive may pass by another station during a trip without needing to stop by it and disconnect trailers for that station if it's not turn for its delivery. In some embodiments, a model for composite delivery tasks may be different than independent delivery tasks as handled by TDS 102.

In some embodiments, TDS 102 may provide a user interface 116 for display on a user terminal, mobile device, laptop, or other screen. The user interface 116 may be accessed by one or more members of the dispatch team to request a shipping route 104 for shipping the total goods 106 to the different requesting railway stations 108A, 108B. In some embodiments, the user may select, via user interface 116, which requests 110 from which stations 108 are to be combined into a single delivery of total goods 106.

In some embodiments, TDS 102 may receive a metric 118 via user interface 116. Metric 118 may be any barometer against which a user wants to measure efficiency or optimization in selecting a shipping route 104. Some example metrics 118 include, but are not limited to: mean time to wait (MTW), and shortest route. Shortest route may be an indication that the user wants the shipping route 104 with the shortest distance to be traveled by the train or other delivery vehicle. In some embodiments, this may be beneficial if there are fuel shortages, price increases on fuel, or a shipping vehicle that is coming due for a scheduled maintenance based on the distances its traveled.

MTW may be a measure that is used to determine the shortest time, more particularly, what is the mean or average time each station has to wait to receive a quantity of goods once the train or shipping vehicle has left the dispatch station. For example, if 100 tons of goods are to be delivered to four different stations, but the furthest station is receiving 80 tons of those goods, reducing the MTW may include delivering to the furthest station first, otherwise the 80 tons would increase the MTW relative to delivering the other 20 tons first. In some embodiments, MTW may be a weighted average, such that if the 80 tons are waiting for 2 hours, that two hours is weighted at ⅘, while the other ⅕ of weight may be distributed across the wait times for the remaining 20 tons to the other three stations. For simplicity, MTW (mean time to wait) will be used as the primary example metric 118.

In some embodiments, TDS 102 may receive a command via user interface 116 to calculate or identify the best shipping route 104 based on the provided metric 118. Responsive to the command or request for shipping route 104, TDS 102 may identify a number of different variations 120 on how the total goods 106 may be shipped to fulfill the grouped requests 110. Variations 120 may include all or a number of different possible routes the train could take to deliver the total goods 106 to the railway stations 108 (subject to any user-provided or job-specific constraints 124 as will be discussed in greater detail below).

In some embodiments, TDS 102 may include a metric calculator 122 which may be used to compute the metric 118 value for each of the variations 120. TDS 102 may also compute or retrieve distances 114. Distances 114 may be an indicator of one or more measures as to the distances the train would be traveling between the different stations 108 in each of the variations 120. In some embodiments, distances 114 may be a mileage/kilometer measure, or an approximated travel time measure. In some embodiments, metric calculator 122 may take into account distances 114 to compute the value of metric 118 for each of the variations 120. For example, taking into account distances 114, and the time it would take to travel those distances 114 at approximated or allowed speeds, metric calculator 122 may calculate the MTW for each of the variations 120.

In some embodiments, once metric calculator 122 has calculated the metric 118 for the variations 120, TDS 102 may select the shipping route 104 with the highest ranking or rated metric 118. For example, TDS 102 may select the variation 120 with the shortest or smallest MTW. TDS 102 may then provide the selected shipping route 104 (with the shortest MTW) to be displayed on user interface 116 as shipping route display 128. A user may then review the shipping route display 128, modify it as needed, and dispatch the shipping route display 128 to other parties responsible for actually procuring and delivering the goods.

In some embodiments, shipping route display 128 may include a map showing the order in which the total goods 106 are to be transported and delivered to the various stations 108. In some embodiments, shipping route display 128 may include a manifest indicating goods or train cars/containers are to be delivered to which station 108.

In some embodiments, the shipping route display 128 may include a time indicator 130. Time 130 may indicate the overall MTW (or other metric 118) to complete delivery of the total goods 106 to all to all of the stations. In some embodiments, time 130 may indicate the individual wait times for each station once the shipment has left the dispatch office. In some embodiments, time 130 may account for, include, or indicate the approximated delivery/unload times at each station 108.

In some embodiments, TDS 102 may receive different constraints 124 on the shipping route 104. These constraints 124 may limit the number of possible variations 120 that could be used or tested with metric 118 or selected as shipping route 104. Constraints 124 may include any factors not already accounted for that may limit what variation 120 may be selected as shipping route 104. Some example constraints 124 may include traffic patterns (indicating which stations 108 may be backed up with previous shipments or other traffic), time constraints (e.g., station 3 may need their shipment within 4 hours), and goods constraints (e.g., the perishable goods going to station 4 must be delivered within 2 hours). In some embodiments, constraints 124 may include or indicate how long it will take to deliver the goods at each station 108 once the train has left the dispatch office or its initial starting point.

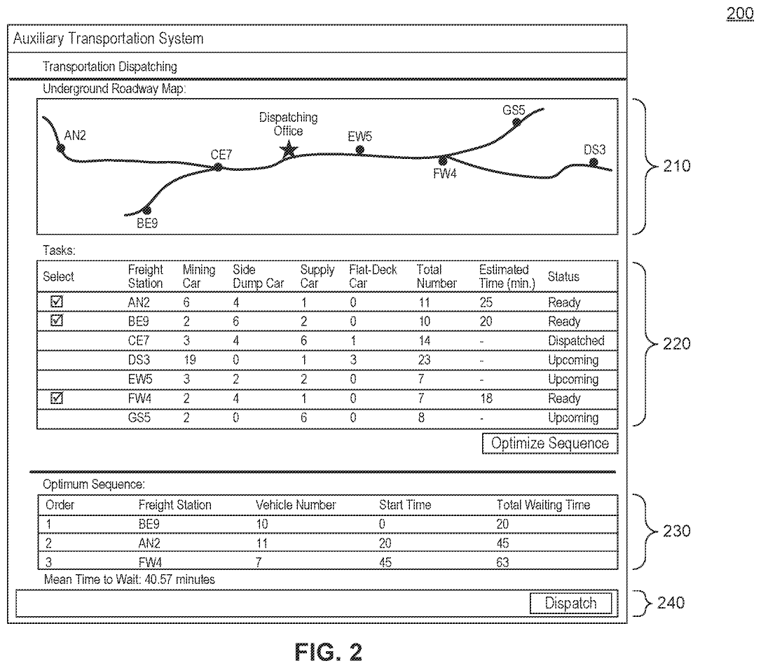

FIG. 2 is an example user interface 200 of TDS 102, according to some example embodiments. In section 210, a map is illustrated showing the dispatching office (from where goods may be shipped), and the various stations that may submit requests 110 and/or receive goods from the dispatch office. The lines connecting the stations may illustrate the train tracks or shipping routes available between the stations. For example, there may be a route from station CE7 to both AN2 and BE9, but no route for a train or other transportation vehicle to go directly from AN2 to BE9. Requests 110 may be received from any of the stations, any of which may be combined together into a single order for total goods 106.

In section 220, the selected stations (for which requests 110 may be aggregated or combined into total goods 106) are illustrated. In the example, stations AN2, BE9, and FW4 may have been selected by a user via user interface 200. In some embodiments, a user may change the selections of which stations or requests are to be combined into the total goods 106 order directly from section 220.

Section 220 may also indicate which types of cars (which carry the goods, materials, or supplies) are going to each station and the status of the cars. In the example illustrated, there may be four different types of cars, each one suited to carry different types of goods or materials. In the example illustrated, station AN2 may receive 11 total cars including 4 mining cars, 4 side-dump cars, 1 supply car, and zero flat-deck cars. Other embodiments may include different types of cars, or cars with different transport volumes or goods-carrying capacities. In some embodiments, TDS 102 may calculate the optimal trailer assignment (e.g., which cars to use in transporting the total goods 106), which is described in further detail below.

Section 230 illustrates an example, shipping route display 128 for the selected stations (from section 220). In the example illustrated, the total goods would be delivered to station BE9 first which would take 20 minutes from when the train leaves the dispatch office. The second stop would be station AN2 which would receive goods 45 minutes after the train leaves the dispatch office, and finally the remainder of the goods may be delivered to FW4 at around minute 63. As illustrated, the metric 118 that was used to compute and select the shipping route 104 was MTW (mean time to wait). The MTW for this combination was 40.57 minutes, which may account for the distances (time to travel) between the stations and the volume of goods to be delivered to each station. In some embodiments, the MTW may either account for or ignore the approximated unload time at each station (e.g., until the train can leave for the next station).

As noted above, a user can also change the selections of the various stations in section 220, due to changing conditions or preferences, and request that a new shipping route 104 be computed and displayed in section 230. For example, the user may decide to add station GS5 to the total goods 106, which may cause TDS 102 to generate new variations 120, compute new MTW metrics 118, and select a new optimized shipping route 104 to be displayed in section 230 (e.g., with the lowest MTW).

In some embodiments, TDS 102 may display multiple variations for simultaneous viewing in section 230. For example, TDS 102 may simultaneously display both the shipping route 104 prior to adding station GS5 and after adding GS5 so that a user may visually compare the differences and then may select the desired shipping route 104/combination of stations. Or, for example, if two shipping route variations 120 have similar MTWs (metric 118) within a threshold, such as 5 minutes, both variations 120 may be displayed and a user may choose the preferred route variation as shipping route 104 directly from interface 200.

In some embodiments, a user may select the dispatch button 240 which may communicate with the systems or individuals responsible for arranging the shipment (e.g., loading the cars with the supplies, and arranging the cars on the train, etc.) to begin the shipment. In some embodiments, the dispatch button 240 may cause the optimum sequence shipping route from section 230 to be uploaded or provided to the train or the engineer so they know their delivery or transport schedule and the order of their deliveries.

As described above, TDS 102 may be configured to minimize the average waiting time (MTW—which is an example of metric 118) of the various requesting stations 108 that are being grouped together in a delivery of total goods 106 (e.g., as indicated in section 220). In some embodiments, MTW may be set as the default metric 118 for metric calculator 122, and a user may optionally provide a different metric via user interface 116.

In some embodiments, metric calculator 122 may apply the following formulas to compute metric 118 (MTW) for each of the variations 120 being tested.

Myᵢⱼ+(xᵢ−xⱼ)≥pⱼ and M(1−yᵢⱼ)+(xⱼ−xᵢ)≥pⱼ

In the example of FIG. 2, there are three different selected stations AN2, BE9, and FW4, which means the jobs cannot be processed simultaneously (which may be an example of a constraint 124). If job i is processed before job j, then the constraint xⱼ≥xᵢ+pᵢ, may be used. Otherwise if job j goes first, then there is a constraint xᵢ≥xⱼ+pⱼ. Between two jobs (job i and job j), one of the stations will be delivered to first and the other job or station will be delivered second. In some embodiments, TDS 102 may test the various combinations of delivering to one of the selected stations first and second, or one prior to the other.

In some embodiments, TDS 102 may calculate or retrieve a processing time for each station. The processing time may include the time of loading or unloading goods as part of the delivery, which may be determined or calculated based on estimated or historical data. As an example, for jobs i in the equations above (i=1, 2, 3) corresponding to stations AN2, BE9, and FW4 respectively, the processing times pᵢ may be 25, 20, and 18 minutes as illustrated in section 220. This processing time may account for the time to unhitch the railway cars that are to be delivered to the particular station, enabling the train to continue on to the next station (while the unhitched cars are then unloaded at the station).

The variable xᵢ may be the start time in minutes for the job i (which may be 1, 2, or 3). The value of yᵢⱼ may be either 1 (if i precedes j), or 0 if (j precedes i) in the variation 120 being tested, i and j denoting two different stations 108 (e.g., AN2, BE9, FW4) between which the goods are being transported.

M may be any constant (preferably an integer) value. M may be a constant that is large enough that it keeps the inequalities active while the other is redundant (depending on which job is processed first). If yᵢⱼ=0, which means job j precedes job i, the former inequality is active, while the latter one is redundant because M is much greater than pⱼ, and vice versa. In this example, TDS 102 may set M=200 with regard to the value that is much greater than or a multiple of the sum of all the processing time of the three jobs.

In some embodiments, TDS 102 may assume that the requests 110 or jobs x₁, x₂, and x₃ are received or processed by the Dispatching Office at around the the same time, the objective is to minimize the mean time to wait (MTW) of all the goods before they reach their freight stations. The waiting time of the goods to AN2 is the time of waiting for processing plus the time of being processed, i.e. x₁+pᵢ=w₁. Likewise, the waiting time of the goods to BE9 and FW4 is x₂+p₂=w₂ and x₃+p₃=w₃, respectively. Since the quantity of goods to the three stations should be taken into account, we may use the number of freight cars as the measurement in this example. In some embodiments, instead of vehicle quantity there are other options that measure goods such as the total weight, or the total value of the goods which may be accounted for in MTW. The quantity of vehicles carrying goods to the stations AN2, BE9, and FW4 are 11, 10, and 7, respectively (as shown in 220).

In the example above, the job sequencing model in this example (as performed by metric calculator 122) may be:

Minimize t=(11w₁+10w₂+7w₃)/(11+10+7)

Which may be subject to the following constraints 124.

$${x}_{1} - {x}_{2} + 200 {y}_{12} \geq 20$$

$$- {x}_{1} + {x}_{2} - 200 {y}_{12} \geq - 175$$

$${x}_{1} - {x}_{3} + 200 {y}_{13} \geq 18$$

$$- {x}_{1} + {x}_{3} - 200 {y}_{13} \geq - 175$$

$${x}_{2} - {x}_{3} + 200 {y}_{23} \geq 18$$

$$- {x}_{2} + {x}_{3} - 200 {y}_{23} \geq - 180$$

$$\begin{matrix}{x}_{1} + 25 = {w}_{1} \\ {x}_{2} + 20 = {w}_{2} \\ {x}_{3} + 18 = {w}_{3}\end{matrix}$$

This may cause metric calculator 122 to come up with the optimum solution or shipping route 104 as provided below, with an MTW of 40.57:

$$\begin{matrix}w 1 = 45 \\ w 2 = 20 \\ w 3 = 63\end{matrix}$$

$$\begin{matrix}x 1 = 20 \\ x 2 = 0 \\ x 3 = 45\end{matrix}$$

$$\begin{matrix}y 12 = 0 ( e . g . , job 2 is processed before job 1 ) \\ y 13 = 1 ( e . g . , job 1 is processed before job 3 ) \\ y 12 = 1 ( e . g . , job 2 is processed before job 3 )\end{matrix}$$

The wait time of 0 (for x2) means that the job 2 transportation job to BE9 should be processed first. The second one is job 1 to AN2 that starts at time 20 minutes. The last one is job 3 to FW4 that starts at time 45 minutes. The goods to BE9, AN2, and FW4 need to wait for 20, 45, and 63 minutes respectively before they can be unhitched or unloaded from the delivery train (e.g., before the train or other delivery vehicle reaches each respective station). Their mean time to wait of all goods is 40.57 minutes. As shown in FIG. 2, the vehicles for freight stations AN2, BE9, and FW4 were ready, which meant they were all ready (loaded on cars) and waiting for dispatch from Dispatching Office dispatching. On this interface, after these tasks were checked and the “Optimize Sequence” button was clicked by the user, the optimum sequence or shipping route 104 was displayed below.

The example above is a simplified job sequencing case that demonstrates how the TDS 102 models or selects an optimized shipping route 104. In order to make the most out of a locomotive capacity, it is often possible to gather enough 18 freight cars that head different freight stations in the same direction along the way. For example, in addition to the 7 freight cars dedicated to FW4, another 11 freight cars to other stations along the same way would be appended, say, to EW5 or GS5, so that the total number of freight cars in this train meets 18. If so, there is an overlap of processing time between the goods to FW4 and EW5 or GS5 as there is a common stretch on their ways, and the total time to wait of the goods should be calculated separately and then summed up.

In some embodiments, deductive inferences may sometimes be drawn from the optimization model above. For example, if the quantities of goods to several freight stations are almost equal, no matter whether the stations are in the same direction, the optimum delivery sequence of the goods to these stations may be the ascending order of their processing time. Thus, the station of the least processing time should be the first station to reach. Similarly, if the processing time of the goods to several freight stations are almost equal, the optimum delivery sequence of the goods to these stations may be the descending order of the quantities of goods to these stations. Thus, the station of the most incoming goods (e.g., the largest proportion of total goods 106) should be the first station to reach.

TDS 102 may enable users at a dispatching office or transportation driver(s) to determine the delivery sequence or shipping route 104 of the total goods 106 (from the various grouped requests 110) to the each of the grouped stations 108. TDS 102 may compute and select the optimal shipping route 104 based on metric 118 which may both save a dispatch officer or engineer the time and energy required to compute a sub-optimal delivery sequence, and save time/money in the shipping the total goods 106 under whatever constraints 124 must be adhered to for the shipment. TDS 102 may provide a configurable user interface 116 that enables a user to provide the various constraints 124 and make changes to what stations 108 may be included in the delivery of the total goods 106.

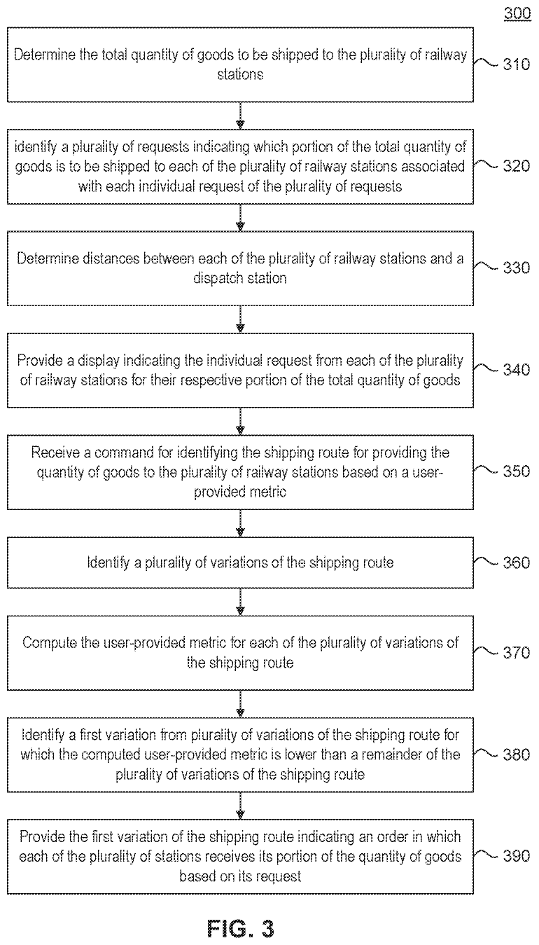

FIG. 3 is a flowchart illustrating a process 300 for identifying a shipping route 104 as performed by a transport dispatch system (TDS) 102, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to the figures.

In 310, the total quantity of goods to be shipped to the plurality of railway stations is determined. For example, a user may select various stations from section 220 of user interface 200 indicating which orders or requests from which stations are to be combined into a single delivery. TDS 102 may aggregate the materials, products, or goods requested across the selected stations 108, to compute total goods 106. In some embodiments, if a delivery vehicle or train has a limited delivery capacity (e.g., 50 tons of goods), then TDS 102 may prevent the user from selecting more than 50 tons of orders and may display an error message if the user tries to exceed the limit.

In 320, a plurality of requests indicating which portion of the total quantity of goods is to be shipped to each of the plurality of railway stations associated with each individual request of the plurality of requests is identified. For example, in FIG. 1, each station 108 may submit a request 110 identifying a quantity 112 indicating how much of each good, material, supply, etc. is requested. TDS 102 may identify how much of or what proportion of total goods 106 is destined for each of the aggregated stations 108. The proportion may be used to help calculate MTW (mean time to wait), in which case those stations with the highest proportions may be delivered to first to reduce MTW.

In 330, distances between each of the plurality of railway stations and a dispatch station are determined. For example, TDS 102 may identify the travel time (which account for allowed or approximated speed on each track) or distances 114 between the various stations or route combinations (travel time/distances between stations after having departed the dispatching office).

In 340, via a user interface, a display indicating the individual request from each of the plurality of railway stations for their respective portion of the total quantity of goods is provided. For example, in FIG. 2, section 220 illustrates which requests from which stations is to be accumulated into a total order. In some embodiments, one station may include multiple different requests, a selection or subset of which may be combined into the total goods 106 order or delivery. The remaining unselected requests for the station may be transported with another delivery. In some embodiments, interface 200 may hide orders that have already been selected for a previous delivery during a previous session.

In 350, a command for identifying the shipping route for providing the quantity of goods to the plurality of railway stations based on a user-provided metric is received. For example, in FIG. 2, TDS 102 may receive a selection of the optimize sequence button requesting the generation or identification of a shipping route 104.

In 360, a plurality of variations of the shipping route are identified. For example, TDS 102 may identify variations 120 on different orders in which the total goods 106 may be transported to and delivered to the proper stations 108 (which may account for or be limited by any user-provided constraints 124). Each variation 120 may indicate a different order of the plurality of railway stations in which to ship the quantity of goods so as to fulfill the selected plurality of requests 110.

In 370, the user-provided metric for each of the plurality of variations of the shipping route is computed. For example, TDS 102 may receive a metric 118 via user interface 116, such as mean time to wait (MTW). Metric calculator 122 may then calculate the metric 118 (MTW) for each of the variations 120.

In 380, a first variation is identified from the plurality of variations of the shipping route for which the computed user-provided metric is lower than a remainder of the plurality of variations of the shipping route. For example, TDS 102 may select the variation 120 for which the computed metric 118 (as calculated by metric calculator 122) is lowest (or highest—depending on the metric 118).

In 390, the first variation of the shipping route indicating an order in which each of the plurality of stations receives its portion of the quantity of goods based on its request is provided via the user interface. For example, in FIG. 2, section 230 illustrates an example optimized sequence for shipping route 104.

When it comes to the transportation of goods, dispatchers have the difficult task of trying to figure out the best way to transport the goods to different locations. This may include needing to decide which transport cars to use to ship or transport the requested goods. The cars a dispatcher chooses to use to transport the goods can impact profitability and productivity of organizations, because using more cars than necessary or less-optimized cars consumes more fuel, wastes manpower, and take more time than using fewer or more efficient cars. However, trying to calculate the best car or transport container combinations can be both difficult, and extraordinarily time consuming because of the number of factors and variables that must be considered.

Returning to FIG. 1, in some embodiments, TDS 102 may be capable of performing additional optimizations with regards to the transportation of goods, beyond choosing the optimal shipping route 104 as described above. For example, in the train example, another way for an organization to reduce costs would be ship the total goods 106 using the fewest number of vehicles, shipping containers, or train cars, because each additional car or container consumes more fuel and requires more workers to load and unload.

In addition to optimizing a shipping route 104, TDS 102 may also or alternatively optimize or generate a trailer assignment 131 (e.g., identifying which types of shipping containers/cars may be used to transport the goods that are destined to multiple different stations 108) which may be output as a trailer assignment display 140. Trying to manually identify a trailer assignment is both time consuming, and likely to produce sub-optimal arrangements that cost additional time and money.

When a dispatch center receives different orders, jobs, or requests 110 from different stations 108, to reduce the transport costs (and/or because of a limited supply of shipping vehicles), the dispatch center may aggregate different requests 110 from different stations 108, into a single aggregated shipment that shares the same transportation vehicle (e.g., container ship, train engine, truck, etc.). As noted above, TDS 102 may identify an optimal shipping route 104, however TDS 102 may also identify an optimal trailer assignment 131.

Vehicle arrangement 131 may help users such as a dispatcher and/or supplier understand how to the arrange/transport/pack the shipments making up the total goods 106 to the various requesting stations 108, so as to use the fewest number of shipping containers or cars (the terms shipping/transport containers and cars may be used interchangeably). An example trailer assignment 131 may include a station identifier 132, a car type 134, a material 136, and a fill level 138 for each of the cars that are being used in the delivery.

Station identifier 132 may indicate which station 108 and/or request number (from request 110) the car or shipping container is destined to fulfill (at least in part). The type 134 may indicate what type of car or container is being used for the shipment of goods (as referenced above, and discussed in greater detail below, there may be multiple different types of cars that may be used to ship different goods or materials). The material 136 may indicate what good is being transported (e.g., water, sand, chemicals, people, gravel, equipment). The fill 138 may indicate a quantity of material 136 or goods that is being transport on the car or within the container. The fill 138 may indicate a particular amount, such as 2 tons, 3 tractors, 1 drill, or a percentage such as 50%.

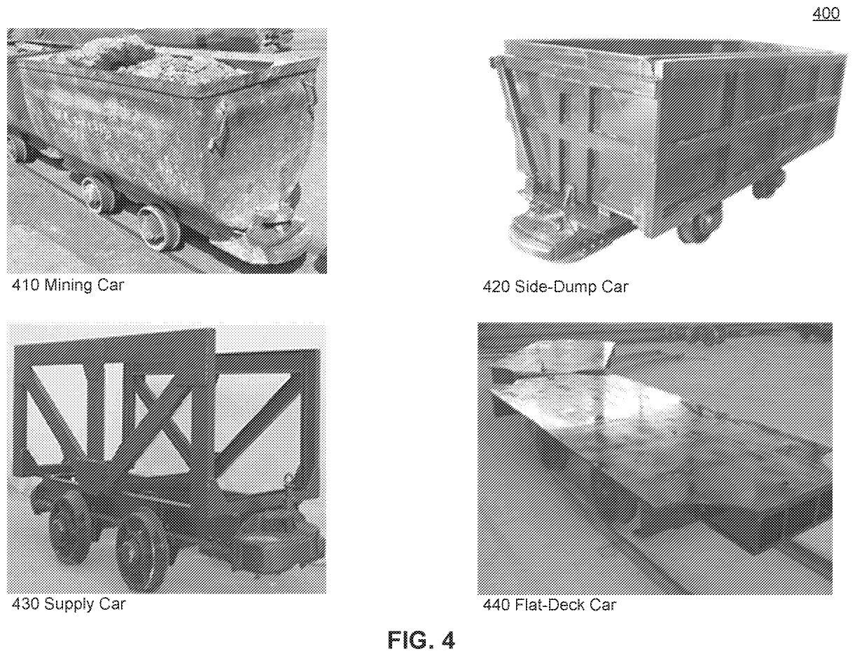

FIG. 4 illustrates several example types 134 of cars that may be used in transporting goods, according to some embodiments. In the example, of FIG. 4, four different types 134 of cars are illustrated. In other embodiments, different types of cars or shipping containers may be used.

The example cars illustrated may be used to deliver goods to various coal mining stations in an underground railroad transportation system, however it is understood that in other embodiments, different cars, stations, and transportation vehicles may be used in different contexts. For example, the different cars may be different shipping containers that are loaded onto a cargo ship that stops at different ports.

As may be seen, each type 134 of car may be configured to ship or transport a different type of material 136. For example, the mining car 410 and side-dump car 420 have different configurations than the supply car 440 and the flat-deck car 440. As an example, either the mining car 410 or side-dump car 420 may be used to transport loose or small materials, such as gravel, sand, dirt, liquids, etc. The supply car 430 may be used to carry boxes, and the flat-deck car 440 may be used to transport machinery or equipment.

Each type of car 410, 420, 430, and 440 may also have its own capacity in terms of how much of a good or material it can transport, which may be measured in size, amount, and/or weight. In some embodiments, each type of car may be registered with a fuel efficiency indicator or rating indicating how much fuel is required to transport the car itself (without any goods in it) or its own weight.

In some embodiments, the different cars may be prohibited from carrying certain materials. For example, liquids, chemicals, water, and hazardous material may have their own special cars and those cars may be prohibited from carrying any other types of material. For example, water car may be prohibited from carrying any other chemicals or liquids. In some embodiments, all these and/or other factors or constraints 124 may be accounted for by TDS 102 in generating the trailer assignment 131.

In some embodiments, TDS 102 may receive a request, via user interface 116 or user interface 200, from a user at a dispatch center for an optimal trailer assignment 130 to make the delivery of the total goods 106 to the various requesting stations 108, in addition to or in lieu of requesting the shipping route 104 (e.g., as indicated by the optimize sequence button).

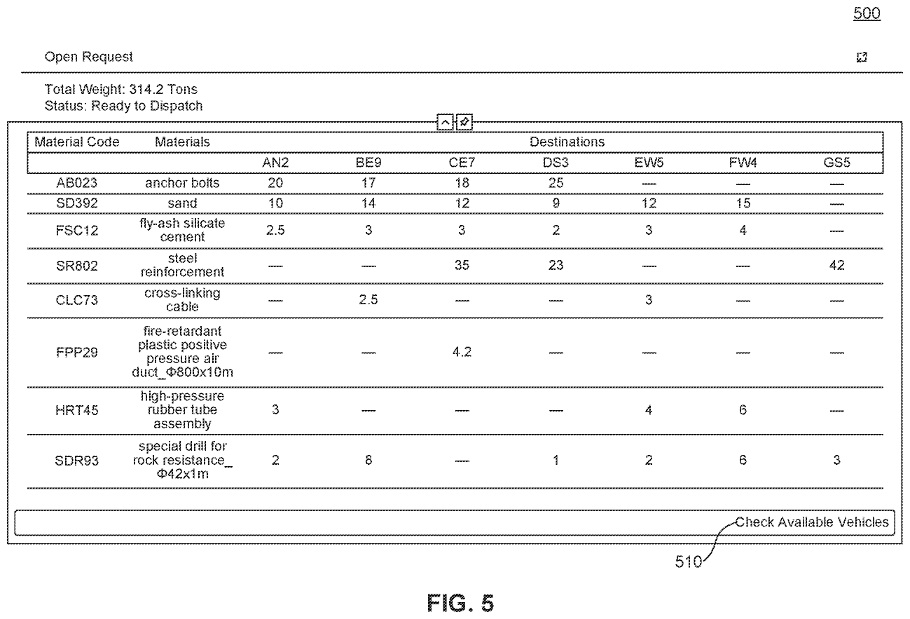

FIG. 5 illustrates an example user interface 500 that illustrates an example open request to be fulfilled, according to some embodiments. As described above, different requests 110 from different stations 108 may be grouped together. Interface 500 illustrates the open requests from the various stations indicating how much material they are requesting and the types of materials being requested.

The various materials that may be transported are illustrated in the first two columns that include a material code and their corresponding material names. The quantity of materials ordered by each station is displayed in the remaining columns. However, not every station or destination listed will be part of the order of total goods 106 to be shipped or transported together. In some embodiments, a user may update the order amounts and select stations from interface 500, as well as limit the transport to a subset of the listed materials. For example, the user may decide that cement and sand cannot be sent together on the same delivery for safety or other reasons. Or, for example, because of supply chain issues, CE7 may only get half of their requested amount (18) of anchor bolts.

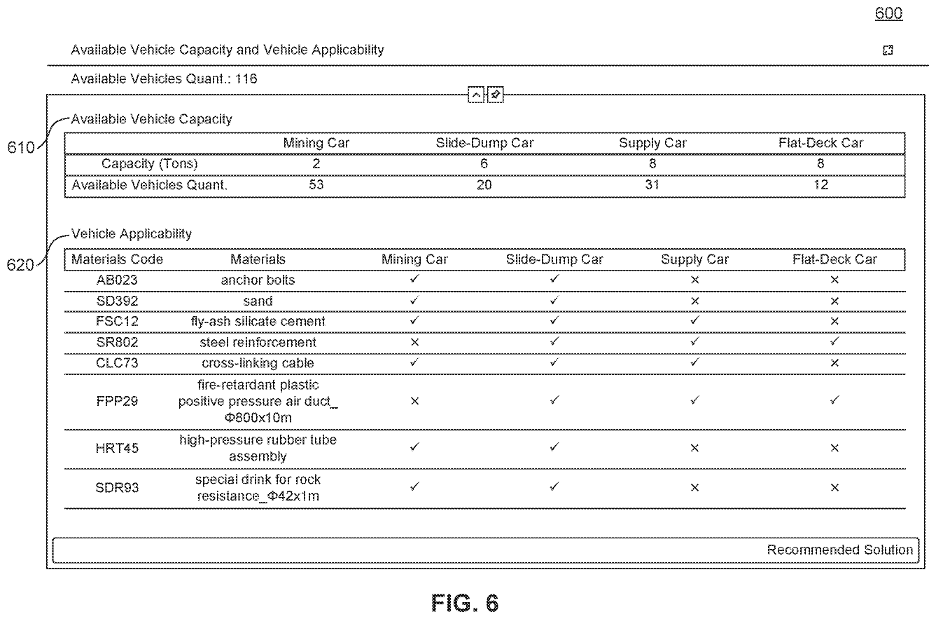

FIG. 6 is an example user interface 600 that illustrates the availability and uses of different types of supply cars that may be used to transport various materials, according to some embodiments.

In section 610, TDS 102 may provide the capacity and availability of each type of car. For example, there may be 53 mining cars, each capable of transporting 2 tons of materials. In other embodiments, section 610 may include additional information such as fuel efficiency or the weight of each type of car (which may impact transportation costs, or limit how much material/how many cars a particular train engine with a weight capacity can pull).

In section 620, TDS 102 may provide the various types of materials and indicate which cars are capable of transporting that particular material. For example, a mining car may be able to transport anchor bolts (as indicated by the check mark) but not fire retardant (as indicated by the x).

In some embodiments, a user may use interface 600 to update the number of available vehicles that are available for the shipment, or may change which vehicles can transport which types of materials in section 620. For example, new regulations may now allow or prohibit certain vehicles from carrying certain types of materials. TDS 102 may use this information in generating an optimal or transport efficient trailer assignment 131.

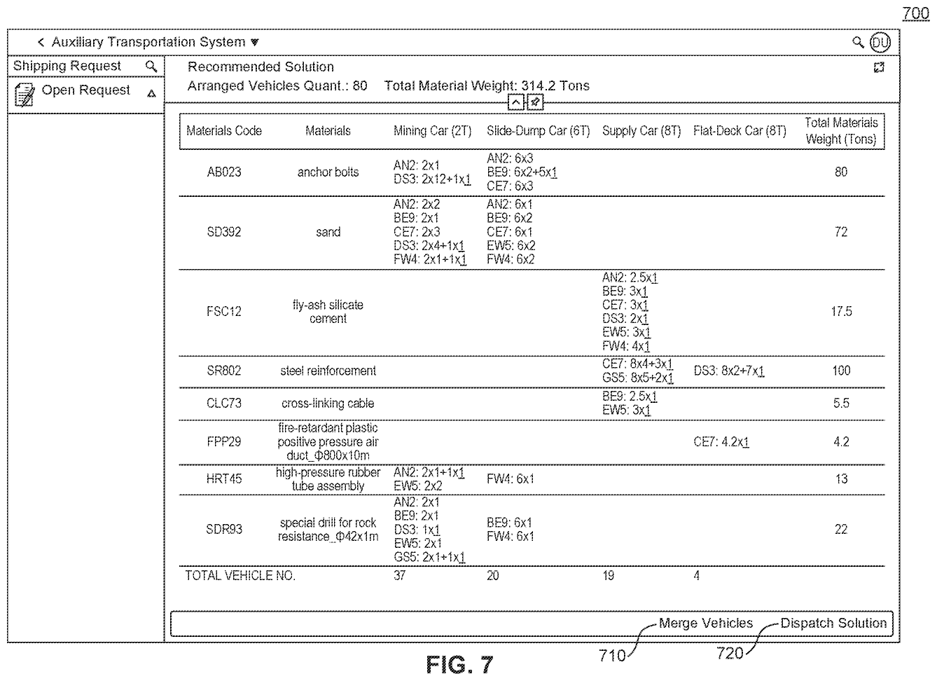

FIG. 7 is an example user interface 700 that illustrates a trailer assignment display 140, according to some embodiments. In the first two columns is displayed a materials code and material name. The next four columns, each correspond to a different type of transportation car, in the parenthesis each car's capacity is indicated. For example, the mining car can carry up to 2 tons of weight.

In the mining car column, the first row indicates the station name (AN2), the capacity (2) and how many cars are filled to capacity (1). In the second row, for station DS3, there are 12 mining cars filled to capacity, and 1 car in which is partially filled with 1 ton of anchor bolts (as indicated by the underlined number).

The column to the far tight indicates how much of each material is to be shipped (e.g., 80 tons of anchor bolts). The bottom row indicates how many of each type of vehicle are needed to complete the order (e.g., 37 mining cars).

TDS 102 may automatically find the optimum strategy of matching the goods to proper vehicles, occupying the fewest vehicles as trailer assignment 131. How to occupy the least number of vehicles while ensuring the completion of transportation tasks is a big challenge. The high volume of goods and variant types of vehicles for daily auxiliary transportation cause the tasks of trailer assignment time-consuming. Conventional manual arrangement may cause improper or inefficient allocation of the resources and, may need more manpower, time, and fuel to complete tasks.

In some embodiments, a user may provide constraints 124 or metrics 118 on the trailer assignment 131. Some examples of user provided constraints 124 or metrics 118 for trailer assignment 131 include: using the fewest total number of cars, using the fewest cars of type X, using the most cars of type Y, and transporting no more than 3 cars of type Z to station Q.

In some embodiments, the dispatching office may be a procurement center that procures or orders the requested materials/goods from various vendors and arranges for their transport to the requesting stations 108. Different types of vehicles have their own features, including their own capacity and their capability or suitability for transporting various goods or materials.

In some embodiments, TDS 102 may calculate the trailer assignment 131 based matching the types of vehicles with the materials that are requested and their destinations and amounts, subject to any user provided constraints 124 or metrics 118. For example, the goods for different destinations may be separately loaded into different cars so that no two stations share goods from the same car (which could increase loading/unloading time).

In some embodiments, when a line of freight cars stops by a station, only the freight cars carrying the goods to the station are disconnected from the train and stationary at the station for unloading goods. The other freight cars in the train continue to go to the next station without waiting for the arrived cars to finish unloading. The unloaded empty cars may then be picked up by another locomotive separately and at a later time. Therefore, for convenience, the freight cars arriving first are usually attached to the rear of a train so that they can be all disconnected at the first station and do not need to be picked up from the middle of the train. The last freight cars to arrive at their station are usually attached to the position nearest to the locomotive at the front. The objective is to minimize the total quantity of all types of vehicles in the processes of delivery for a batch of orders. In some embodiments, TDS 102 may include an ordering of the cars in the trailer assignment display 140.

In some embodiments, TDS 102 (e.g., metric calculator 122) may use the following formula to solve the trailer assignment problem (in which the fewest total number of cars is the metric 118):

minimize q=Σₖ₌₁ⁿΣⱼ₌₁^{m}Σᵢ₌₁^{v}xᵢⱼₖ

In which “q” is the quantity of cars that are being used to transport the total goods 106 and xᵢⱼₖ is the quantity of type i vehicles for transporting material j to destination k.

In some embodiments, the formula above could be subject to the following constraints 124:

Σᵢ₌₁^{v}cᵢxᵢⱼₖ≥dⱼₖ, all j and k

Σₖ₌₁ⁿΣⱼ₌₁^{m}xᵢⱼₖ≤aᵢ, all i

In which aᵢ indicates a quantity of available type i vehicles, cᵢ indicates a maximum capacity of the type i vehicles, and dⱼₖ indicates a desired quantity of material j for requestor k.

It seems that the set of variables xᵢⱼₖ are like a complete 3-dimension cubic for all i, j, and k, however, due to the applicability of certain vehicle types to transport particular materials (and not other materials), some variables of xᵢⱼₖ are inapplicable. For example, if the type 2 vehicle is not applicable to transport material 3, all the x₂₃ₖ (k=1, 2, . . . , n) are inapplicable. The applicability of vehicles to particular materials are stored as master data by TDS 102, as illustrated in FIG. 6.

The requestors' orders are assembled and rendered on the interface 500 of FIG. 5. As noted above, the interface 500 shows the desired quantity of each material by requestors (destinations) whose codes are AN2, BE9, CE7, DS3, EW5, FW4, and GS5. If a material is not requested by the requestor, the corresponding blank in the table is filled with a dash. For example, the anchor bolts in the first row are requested by AN2 for 20 tons, BE9 for 17 tons, CE7 for 18 tons, and DS3 for 25 tons, but not requested by EW5, FW4, or GS5. Likewise, the fire-retardant plastic positive pressure air duct in the sixth row is only requested by CE7 for 4.2 tons.

If the requestors in this table are sequentially numbered from 1 to 7, and the materials are numbered from 1 to 8, the parameters d₁₁=20, d₁₂=17, d₁₃=18, d₁₄=25, and d₁₅=d₁₆=d₁₇=0 denote the desired quantity in the first row. Likewise, d₆₃=4.2 with other d₆ₖ=0 (k=1, 2, 4, . . . , 7) denotes the desired quantity in the sixth row. Each dⱼₖ is corresponding to a nonzero number in this table. In some embodiments, the goods for transportation may be more or equal the requestors' desired quantity so as to meet their requirements. As illustrated, there are 31 orders of the desired material quantity from the information given by this table. In addition, the “Material Code” is the code that symbolizes each material as may be used in a database. When the user clicks the button “Check Available Vehicles” at the bottom right, interface 600 of FIG. 6 with available vehicles and their applicability to the materials may be loaded into a browser as a webpage, or otherwise displayed on the screen of a user device.

As described above, there may be four types of vehicles for auxiliary transportation on the roadway, the mining car, side-dump car, supply car, and flat-deck car, all of which are collectively called freight cars. Their respective maximum capacity cᵢ (i=1, 2, 3, 4) and available quantity aᵢ are shown on the upper side of the interface 600. The sum of each type of vehicles occupied should not exceed its available quantity in this table, which constitutes another 4 constraints on the model.

On the lower side of the interface 600, a green “√” sign may indicate the corresponding vehicle at the header is applicable to the corresponding material on the left, while a red “x” sign may indicate inapplicability. The vehicle applicability arises from the considerations of item size, transportation safety, loading/unloading convenience, and other reasons. For example, the mining car 410 and side-dump car 420 are applicable to sand because both of them can serve as a container for the sand. On the contrary, the supply car 430 and flat-deck car 440 are not applicable to sand because they do not have tight enclosure to contain the loose sand. Therefore, the variables x₃₂ₖ and x₄₂ₖ are inapplicable and should be deleted for any k of 1, 2, . . . , 7. Inapplicable variables removed, a total of 74 applicable variables remain in the model of this case. This would increase the speed of processing of metric calculator 122 or TDS 102 when computing the trailer assignment 131.

A command for computing the trailer assignment 131 is received when the user clicks the button “Recommended Solution” at the bottom right. Next, the metric calculator 122 may calculates the optimal solution of the model and outputs it onto the interface. It turns out that at least 80 freight cars in all are needed, including 37 mining cars, 20 side-dump cars, 19 supply cars, and 4 flat-deck cars.

In the resultant interface 700, of FIG. 7, displays how many cars of each type would be occupied by particular materials to a destination. In some embodiments, green numbers may denote the quantity of full freight cars (to the maximum capacity), while red numbers (or underlines) may denote the freight cars that are loaded with some goods but not full. For example, on the first row, “AN2: 2×1” in the column of mining car and “AN2: 6×3” in column of side-dump car mean that 1 full mining car (2 tons each) and 3 full side-dump (6 tons each) cars will carry 2×1+6−3=20 tons of anchor bolts in all to destination AN2, which will meet the request of 20 tons from AN2 on interface 500 of FIG. 5.

Likewise, “DS3: 2×12+1×1” means that 12 full mining cars (2 tons each) and another 1 mining car (only 1 ton, not full) to destination DS3, equal to 25 tons of anchor bolts as requested. By default, different materials may not be allowed to be mixed into a freight car in order to save a car unless the user click the “Merge Vehicles” button at the bottom right to do so. If user clicks this button, more settings will be rendered for the user selecting and the user should check the items one by one on another interface.

However, mixture of different materials or items in a freight car may spawn problems, e.g. damage to equipment, and is restricted by several conditions, so the user should be prudent to do so. If the users confirm the trailer assignment solution on this webpage, they can dispatch this solution by clicking the “Dispatch Solution” button, and workers will execute the task of loading goods. In some embodiments, the interface 500 may include access to historical or previously dispatched tasks, by which the user can review the outgoing vehicles with goods.

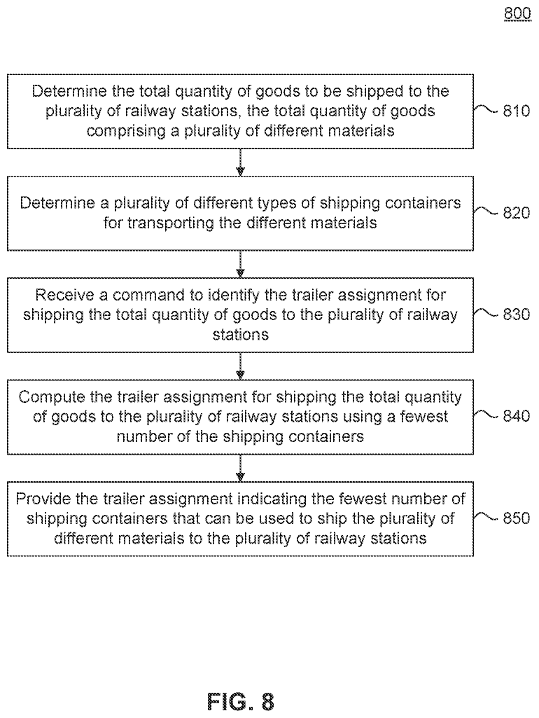

FIG. 8 is a flowchart illustrating a process 800 for generating a trailer assignment 131 as performed by a transport dispatch system (TDS) 102, according to some embodiments. Method 800 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art. Method 800 shall be described with reference to the figures.

In 810, the total quantity of goods to be shipped to the plurality of railway stations is determined, the total quantity of goods comprising a plurality of different materials. For example, FIG. 6 illustrates the quantities and types of materials being requested by the various stations. In some embodiment, a user may select a subset of the requested materials to group together into a single shipment/transport.

In 820, a plurality of different types of shipping containers for transporting the different materials are determined. For example, in FIG. 6, each shipping container is illustrated as is their constraints in terms of what types of materials and the capacity of materials they are able to carry or transport.

In 830, a command to identify the trailer assignment for shipping the total quantity of goods to the plurality of railway stations is received. For example, in FIG. 6, a user may select the “Recommend Solution” button to trigger a generation of the trailer assignment 131 by TDS 102.

In 840, the trailer assignment for shipping the total quantity of goods to the plurality of railway stations using a fewest number of the shipping containers is computed. For example, metric calculator 122 may compute which shipping containers could be used to ship the various requested quantities 112 of total goods 106 to the requesting stations 108 that were aggregated together for a single transport. TDS 102 may identify which shipping container combination would use the fewest numbers of shipping containers or cars.

In 850, the trailer assignment indicating the fewest number of shipping containers that can be used to ship the plurality of different materials to the plurality of railway stations is provided. For example, in FIG. 7, interface 700 illustrates an example trailer assignment display 140. From this interface 700, a user may merge the vehicles 710 (to include different materials in the same car or use the same car to deliver to different stations). Or, the user may dispatch the solution 720 which may send a message to the responsible parties to arrange the transport cars as displayed.

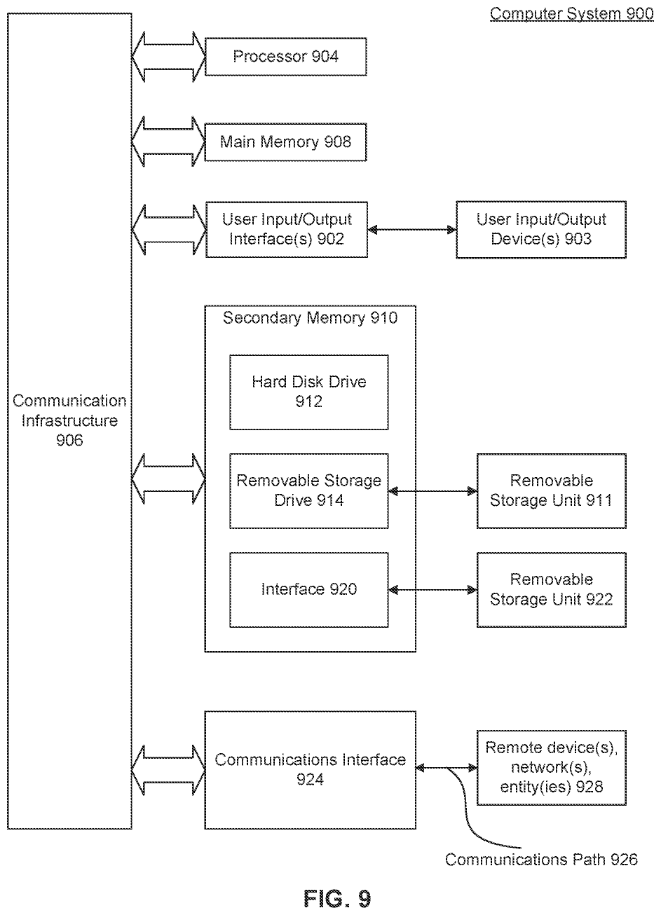

Various embodiments and/or components therein can be implemented, for example, using one or more computer systems, such as computer system 900 shown in FIG. 9. Computer system 900 can be any computer or computing device capable of performing the functions described herein. For example, one or more computer systems 900 can be used to implement any embodiments, and/or any combination or sub-combination thereof.

Computer system 900 includes one or more processors (also called central processing units, or CPUs), such as a processor 904. Processor 904 is connected to a communication infrastructure or bus 906. Computer system 900 may represent or comprise one or more systems on chip (SOC).

One or more processors 904 can each be a graphics processing unit (GPU). In some embodiments, a GPU is a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 900 also includes user input/output device(s) 903, such as monitors, keyboards, pointing devices, etc., that communicate with communication infrastructure 906 through user input/output interface(s) 902.

Computer system 900 also includes a main or primary memory 908, such as random access memory (RAM). Main memory 908 can include one or more levels of cache. Main memory 908 has stored therein control logic (i.e., computer software) and/or data.

Computer system 900 can also include one or more secondary storage devices or memory 910. Secondary memory 910 can include, for example, a hard disk drive 912 and/or a removable storage device or drive 914. Removable storage drive 914 can be a floppy disk drive, a magnetic tape drive, a compact disk drive, an optical storage device, tape backup device, and/or any other storage device/drive.

Removable storage drive 914 can interact with a removable storage unit 918. Removable storage unit 918 includes a computer usable or readable storage device having stored thereon computer software (control logic) and/or data. Removable storage unit 918 can be a floppy disk, magnetic tape, compact disk, DVD, optical storage disk, memory card, and/any other computer data storage device. Removable storage drive 914 reads from and/or writes to removable storage unit 918 in a well-known manner.

According to an exemplary embodiment, secondary memory 910 can include other means, instrumentalities or other approaches for allowing computer programs and/or other instructions and/or data to be accessed by computer system 900. Such means, instrumentalities or other approaches can include, for example, a removable storage unit 922 and an interface 920. Examples of the removable storage unit 922 and the interface 920 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 can further include a communication or network interface 924. Communication interface 924 enables computer system 900 to communicate and interact with any combination of remote devices, remote networks, remote entities, etc. (individually and collectively referenced by reference number 928). For example, communication interface 924 can allow computer system 900 to communicate with remote devices 928 over communications path 926, which can be wired and/or wireless, and which can include any combination of LANs, WANs, the Internet, etc. Control logic and/or data can be transmitted to and from computer system 900 via communication path 926.

In some embodiments, a tangible apparatus or article of manufacture comprising a tangible computer useable or readable medium having control logic (software) stored thereon is also referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections can set forth one or more but not all exemplary embodiments as contemplated by the inventors, and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method for identifying a shipping route for a total quantity of goods to a plurality of railway stations, the method comprising:
determining the total quantity of goods to be shipped to the plurality of railway stations;
identifying a plurality of requests indicating which portion of the total quantity of goods is to be shipped to each of the plurality of railway stations associated with each individual request of the plurality of requests;
determining distances between each of the plurality of railway stations and a dispatch station;
providing, via a user interface, a display indicating the individual request from each of the plurality of railway stations for their respective portion of the total quantity of goods;
receiving, via the user interface, a command for identifying the shipping route for providing the portion of the total quantity of goods to the plurality of railway stations based on a user-provided metric;
identifying a plurality of variations of the shipping route, each variation indicating a different order of the plurality of railway stations in which to ship the portion of the total quantity of goods so as to fulfill the plurality of requests;
computing the user-provided metric for each of the plurality of variations of the shipping route;
identifying a first variation from the plurality of variations of the shipping route for which the computed user-provided metric is lower than a remainder of the plurality of variations of the shipping route; and
providing, via the user interface, the first variation of the shipping route indicating an order in which each of the plurality of railway stations receives its portion of the total quantity of goods based on its request.

2. The method of claim 1, wherein the user-provided metric comprises a mean wait time.

3. The method of claim 2, wherein the portion of the total quantity of goods requested by each of the plurality of railway station comprises a fractional portion of the total quantity of goods, and wherein the fractional portion is weighted accordingly in computing the mean wait time.

4. The method of claim 3, wherein the total quantity of goods is a weight indicator.

5. The method of claim 1, further comprising:
receiving, via the user interface, one or more constraints for the shipping route.

6. The method of claim 1, wherein the providing comprises displaying a total waiting time for receiving its portion of the total quantity of goods for each of the plurality of railway stations on the user interface.

7. The method of claim 1, wherein the shipping route is configured for a single train to transport the total quantity of goods to all of the plurality of railway stations.

8. The method of claim 7, wherein the providing comprises displaying a plurality of different carts for the single train that are to be delivered to each of the plurality of railway stations.

9. The method of claim 7, wherein the distances comprise time distances indicating how long it will take the single train to travel to each of the plurality of railway stations.

10. A system for identifying a shipping route for a total quantity of goods to a plurality of railway stations comprising at least one processor, the at least one processor configured to perform operations comprising:
determining the total quantity of goods to be shipped to the plurality of railway stations;
identifying a plurality of requests indicating which portion of the total quantity of goods is to be shipped to each of the plurality of railway stations associated with each individual request of the plurality of requests;
determining distances between each of the plurality of railway stations and a dispatch station;
providing, via a user interface, a display indicating the individual request from each of the plurality of railway stations for their respective portion of the total quantity of goods;
receiving, via the user interface, a command for identifying the shipping route for providing the portion of the total quantity of goods to the plurality of railway stations based on a user-provided metric;
identifying a plurality of variations of the shipping route, each variation indicating a different order of the plurality of railway stations in which to ship the portion of the total quantity of goods so as to fulfill the plurality of requests;
computing the user-provided metric for each of the plurality of variations of the shipping route;
identifying a first variation from the plurality of variations of the shipping route for which the computed user-provided metric is lower than a remainder of the plurality of variations of the shipping route; and
providing, via the user interface, the first variation of the shipping route indicating an order in which each of the plurality of railway stations receives its portion of the total quantity of goods based on its request.

11. The system of claim 10, wherein the user-provided metric comprises a mean wait time.

12. The system of claim 11, wherein the portion of the total quantity of goods requested by each of the plurality of railway stations comprises a fractional portion of the total quantity of goods, and wherein the fractional portion is weighted accordingly in computing the mean wait time.

13. The system of claim 12, wherein the total quantity of goods is a weight indicator.

14. The system of claim 10, the operations further comprising:
receiving, via the user interface, one or more constraints for the shipping route.

15. The system of claim 10, wherein the providing comprises displaying a total waiting time for receiving its portion of the total quantity of goods for each of the plurality of railway stations on the user interface.

16. The system of claim 10, wherein the shipping route is configured for a single train to transport the total quantity of goods to all of the plurality of railway stations.

17. The system of claim 16, wherein the providing comprises displaying a plurality of different carts for the single train that are to be delivered to each of the plurality of railway stations.

18. The system of claim 16, wherein the distances comprise time distances indicating how long it will take the single train to travel to each of the plurality of railway stations.

19. A non-transitory computer-readable medium for identifying a shipping route for a total quantity of goods to a plurality of railway stations, the non-transitory computer-readable medium having instructions stored thereon that, when executed by at least one computing device, cause the at least one computing device to perform operations comprising:
determining the total quantity of goods to be shipped to the plurality of railway stations;
identifying a plurality of requests indicating which portion of the total quantity of goods is to be shipped to each of the plurality of railway stations associated with each individual request of the plurality of requests;
determining distances between each of the plurality of railway stations and a dispatch station;
providing, via a user interface, a display indicating the individual request from each of the plurality of railway stations for their respective portion of the total quantity of goods;
receiving, via the user interface, a command for identifying the shipping route for providing the portion of the total quantity of goods to the plurality of railway stations based on a user-provided metric;
identifying a plurality of variations of the shipping route, each variation indicating a different order of the plurality of railway stations in which to ship the portion of the total quantity of goods so as to fulfill the plurality of requests;
computing the user-provided metric for each of the plurality of variations of the shipping route;
identifying a first variation from the plurality of variations of the shipping route for which the computed user-provided metric is lower than a remainder of the plurality of variations of the shipping route; and
providing, via the user interface, the first variation of the shipping route indicating an order in which each of the plurality of railway stations receives its portion of the total quantity of goods based on its request.

20. The non-transitory computer-readable medium of claim 19, wherein the user-provided metric comprises a mean wait time.
